(19) United States
(12) Patent Application Publication
(10) Pub. No.: US 2011/0129573 A1
(43) Pub. Date: Jun. 2, 2011

(54) Soy Protein-Based Nutritional Formula with Superior Stability

(76) Inventors: Daniel S. Albrecht, Columbus, OH (US); John B. Lasekan, Worthington, OH (US)

(21) Appl. No.: 12/951,125

(22) Filed: Nov. 22, 2010

Related U.S. Application Data
(60) Provisional application No. 61/265,524, filed on Dec. 1, 2009.

(51) Int. Cl. A23L 1/302; A23L 1/30

(52) U.S. Cl. 426/72; 426/648

(57) ABSTRACT

The present disclosure relates to soy protein-based powdered nutritional formulas, such as infant or toddler formulas, that contain lutein and fructooligosaccharide (FOS). The FOS stabilizes lutein present in the formula, resulting in less lutein degradation over the shelf-life of the formula. When fed to infants, the nutritional formulas provide an infant stool pattern, frequency, and color more closely resembling that of breastfed infants.

This application claims the benefit of U.S. Provisional Application No. 61/265,524 filed Dec. 1, 2009

### BACKGROUND OF DISCLOSURE

The present disclosure relates to soy protein-based powdered nutritional formulas, such as infant or toddler formulas, that contain lutein and fructooligosaccharide (FOS). When fed to infants, the nutritional formulas provide an infant stool pattern, and optionally, a stool frequency and color, more closely resembling that of breastfed infants.

Dietary carotenoids are lipid soluble compounds abundant in fruits and vegetables. Carotenoids are responsible for the spectrum of color found in fruits and vegetables, and are also responsible for the coloring of some birds and shellfish. Hundreds of carotenoid compounds have been identified, and approximately 30 of these compounds have been detected in human serum, milk, and other tissues (Khachik, et al., “Chemistry, distribution, and metabolism of tomato carotenoids and their impact on human health,” Exp. Biol. Med. 2002, Vol. 227:845-851).

Carotenoids have been reported to have health benefits. For example, carotenoids have been reported to regulate immune function and gap junction protein expression. With the growing awareness of the benefits of carotenoid intake, the absorption of these compounds from the diet becomes an important factor in the delivery and physiological action of these nutrients.

To this end, carotenoids, such as lutein, are sometimes incorporated into nutritional formulas, including infant and toddler formulas. However, certain nutritional formulas that comprise lutein suffer from instability. In particular, lutein present in the formula may oxidize and degrade over the shelf life of the formula. Consequently, when the formula is used, the amount of lutein present in the formula may be significantly less than what was present in the formula when originally formulated.

Milk protein-based formulas contain inherent lactose that is not acceptable to certain populations. For instance, some infants experience feeding problems such as fussiness, gas, and spit-up, with milk protein-based infant formulas. Some infants may also have allergies or sensitivities to cow's milk-protein, or disorders for which lactose from cow's milk should be avoided. Soy protein does not, however, contain lactose, and thus soy protein is appropriate for use in producing a lactose-free product. Known soy protein-products, however, have been found to have lutein instability.

It has now been unexpectedly discovered that a soy protein-based powdered nutritional formula comprising lutein exhibits more stability of the lutein when FOS is added to the formulation, as compared to the same formulation that does not contain FOS. It has furthermore been unexpectedly discovered that a soy protein-based powdered nutritional formula comprising lutein and FOS provides an infant stool pattern, frequency, and color more closely resembling that of breastfed infants, than conventional soy protein-based infant formulas that do not comprise FOS.

### SUMMARY OF THE DISCLOSURE

The present disclosure is directed to a powdered nutritional formula comprising per 100 g of formula: from about 15 μg to about 300 μg of lutein; from about 0.5 g to about 7 g of a fructooligosaccharide; and soy protein.

In another aspect, the present disclosure is directed to a method for improving the stool pattern of a formula-fed infant. The method comprises reconstituting a powdered infant formula comprising, per 100 g of formula, from about 15 μg to about 300 μg of lutein; from about 0.5 g to about 7 g of a fructooligosaccharide; and soy protein; and administering the reconstituted infant formula to the infant.

It has been unexpectedly discovered that a soy protein-based powdered nutritional formula, such as an infant or toddler formula, comprising lutein exhibits more stability of the lutein when FOS is added to the formula, as compared to the same formula that does not contain FOS. The addition of FOS results in less lutein degradation over the shelf-life of the formula. It has furthermore been discovered that a soy protein-based powdered nutritional formula comprising lutein and FOS provides an infant stool pattern, frequency, and color more closely resembling that of breastfed infants, than conventional soy protein-based infant formulas that do not comprise FOS.

### DETAILED DESCRIPTION OF THE DISCLOSURE

The present disclosure is directed to soy protein-based powdered nutritional formulas, such as infant or toddler formulas, that contain lutein and fructooligosaccharide (FOS). The addition of FOS to a soy protein-based powdered formula stabilizes lutein present in the formula, resulting in less lutein degradation over the shelf-life of the formula. The present disclosure further provides methods for improving the stool pattern of formula fed infants. Specifically, when fed to infants, the nutritional formulas of the present disclosure provide an infant stool pattern, frequency, and color more closely resembling that of breastfed infants. These and other essential or optional elements or limitations of the powdered nutritional formulas and methods of the present disclosure are described in detail hereafter.

The term “infant” as used herein, unless otherwise specified, refers to children not more than about one year of age, and includes infants from 0 to about 4 months of age, infants from about 4 to about 8 months of age, infants from about 8 to about 12 months of age, low birth weight infants at less than 2,500 grams at birth, and preterm infants born at less than about 37 weeks gestational age, typically from about 26 weeks to about 34 weeks gestational age. The term “child” or “children” as used herein refers to children not more than 12 years of age, and includes children from about 12 months to about 12 years of age. The term “toddler” refers to a child of from about 12 months to about 4 years of age. The term “adult” as used herein refers to adults and children about 12 years and older.

The term “infant formula” as used herein, unless otherwise specified, refers to a nutritional composition designed for infants that contains sufficient nutrients such as proteins, carbohydrates, lipids, vitamins, and minerals to potentially serve as a supplemental, primary, or sole source of nutrition.

The term “toddler formula” as used herein, unless otherwise specified, refers to a nutritional composition designed for toddlers that contains sufficient nutrients such as proteins, carbohydrates, lipids, vitamins, and minerals to potentially serve as a supplemental, primary, or sole source of nutrition.

The term “nutritional formula” as used herein, unless otherwise specified, refers to a nutritional composition designed for infants, toddlers, children, adults, or combinations thereof, that contains sufficient nutrients such as proteins, carbohydrates, lipids, vitamins, minerals, and electrolytes to potentially serve as a supplemental, primary, or sole source of nutrition.

As used herein, the term “stool pattern” relates to a kind of defecation that an individual experiences as a result of nutritional intake. To “improve the stool pattern of a formula-fed infant” means to reduce the actual or perceived difference between the feces consistency, frequency, and/or color of breastfed infants and those fed a conventional infant formula. The consumption of typical infant formula results in infant stools that are firmer/harder than the stools resulting from the consumption of human milk. Human milk is considered the “gold standard” by parents and professional care givers alike. Infants fed breast milk have stools that can be described as between watery and slightly above loose/mushy, when evaluated on a five point scale (watery=1, loose/mushy=2, soft1=3, formed=4 and hard=5). Typically, the stool of breast fed infants is also yellowish in color. In contrast, the stool of soy formula-fed infants is typically green or brown. Additionally, the frequency of stools (i.e., number of stools per day) is higher in breastfed infants than in formula-fed infants. Thus, the term “improving the stool pattern” means defecation consistency, stool frequency, and/or stool color that more closely resembles that of the breastfed infant.

All percentages, parts and ratios as used herein, are by weight of the total composition, unless otherwise specified. All such weights as they pertain to listed ingredients are based on the active level and, therefore, do not include solvents or by-products that may be included in commercially available materials, unless otherwise specified.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The formulas of the present disclosure, including nutritional formulas, such as infant and toddler formulas, may also be substantially free of any optional or selected essential ingredient or feature described herein, provided that the remaining formula still contains all of the required ingredients or features as described herein. In this context, and unless otherwise specified, the term “substantially free” means that the selected formula contains less than a functional amount of the optional ingredient, typically less than 0.1% by weight, and also including zero percent by weight of such optional or selected essential ingredient.

The compositions, nutritional formulas, infant formulas, toddler formulas, and corresponding methods of the present disclosure can comprise, consist of, or consist essentially of the essential elements and limitations of the disclosure as described herein, as well as any additional or optional ingredients, components, or limitations described herein or otherwise useful in nutritional formula applications.

### Soy Protein

The powdered nutritional formulas of the present disclosure comprise soy protein. Soy-based nutritional formulas, including soy based infant formulas, are well known and readily available from a number of commercial sources, including Similac® Isomil® Advance® Infant Formulas available from Abbott Nutrition, Abbott Laboratories, Columbus, Ohio. These soy-based formulas are prepared especially for infants with feeding problems such as fussiness, gas, and spit-up, as well as for infants whose parents choose a non-milk-based formula as a first feeding or as a supplement to breastfeeding. These soy-based formulas are especially helpful for those infants with allergies or sensitivities to cow's-milk protein, and for those infants with disorders for which lactose from cow's milk should be avoided.

Typically, at least about 15% of the total protein in the powdered nutritional formulas of the present disclosure is soy protein. More typically, at least about 50% of the total protein in the powdered nutritional formula is soy protein, and still more typically, at least about 75% of the total protein in the powdered nutritional formula is soy protein. In one embodiment, 100% of the total protein in the powdered nutritional formula is soy protein.

The soy protein-based powdered nutritional formulas of the present disclosure may comprise any suitable source of soy protein. Examples of suitable sources of soy protein include, but are not limited to, soy flakes, soy protein isolates, soy protein concentrate, hydrolyzed soy protein, soy flour, soy protein fiber, soy whey, or any other protein or protein source derived from soy or mixtures thereof. The soy protein suitable for use in the powdered nutritional formulas of the present disclosure includes extensively hydrolyzed, partially hydrolyzed or non-hydrolyzed soy proteins or protein sources.

Commercial sources of soy protein are also well known in the nutrition art, some non-limiting examples of which include soy protein isolates distributed by The Solae Company (St. Louis, Mo.) under the trade designation Soy Protein Isolate EXP-H0118, EXP-E-0101, SUPRO PLUS 675, SUPRO 670, SUPRO 710, SUPRO 620, SUPRO 500E, SUPRO 630, and SUPRO EX33; and PROFAM 931, PROFAM 873, and PROFAM 891, available from Archer Daniels Midland (Decatur, Ill.). Soy protein isolates derived in whole or in part from any phytase treatment method that is known or otherwise suitable for effectively reducing inherent phytic acid concentrations in the resulting protein isolate may also be used. Examples of such soy protein isolates and methods of producing them are described in U.S. Pat. No. 7,323,200, herein incorporated by reference in its entirety.

### Carotenoids

The powdered nutritional formulas of the present disclosure comprise the carotenoid lutein. It is generally preferable that the powdered nutritional formula of the present disclosure comprise, per 100 g of formula, from about 15 ug to about 300 ug of lutein, including from about 15 μg to about 175 μg of lutein, from about 18 μg to about 165 μg of lutein, and from about 20 μg to about 160 μg of lutein.

Optionally, the powdered nutritional formulas may further comprise an additional carotenoid selected from the group consisting of lycopene, beta-carotene, and combinations thereof. In embodiments comprising lycopene, the powdered nutritional formula will typically comprise, per 100 g of formula, from about 10 μg to about 200 μg of lycopene, including from about 40 ug to about 105 ug of lycopene, from about 46 μg to about 95 μg of lycopene, and from about 50 μg to about 93 μg of lycopene. In embodiments comprising beta-carotene, the powdered nutritional formula will typically comprise, per 100 g of formula, from about 10 μg to about 200 μg of beta-carotene, including from about 15 ug to about 125 ug of beta-carotene, from about 18 μg to about 110 μg of beta-carotene, and from about 19 μg to about 104 μg of beta-carotene.

In other embodiments, the powdered nutritional formula of the present disclosure may be substantially free of lycopene and/or substantially free of beta-carotene.

Each of the carotenoids can be obtained from any known or otherwise suitable material source for use in nutritional formulas, and each can be provided individually, or all together, or in any combination and from any number of sources, including sources such as multivitamin premixes containing other vitamins or minerals in combination with one or more of the carotenoids as described herein. Any one or all of the carotenoids included in the nutritional formulas described herein may be from a natural source, or artificially synthesized. Non-limiting examples of some suitable sources of lutein, lycopene, beta-carotene, or combinations thereof include LycoVit® lycopene (available from BASF, Mount Olive, N.J.), Lyc-O-Mato® tomato extract in oil, powder, or bead form (available from LycoRed Corp., Orange, N.J.), beta-carotene, lutein, or lycopene available from DSM Nutritional Products, Parsippany, N.J.), FIoraGLO® lutein (available from Kemin Health, Des Moines, Iowa), Xangold® Natural Lutein Esters (available from Cognis, Cincinnati, Ohio), and Lucarotin® beta-carotene (available from BASF, Mount Olive, N.J.).

### Fructooligosaccharides (FOS)

The powdered nutritional formulas of the present disclosure include at least one fructooligosaccharide. As discussed above, lutein present in soy protein-based nutritional formulas may oxidize and degrade over the shelf life of the formula. Consequently, by the time the formula is used, the amount of lutein present in the formula may be significantly less than what was present in the formula when originally formulated.

It has now unexpectedly been discovered that the addition of FOS to a soy protein-based powdered nutritional formula increases the stability of lutein present in the formula, as compared to the same formula that does not contain FOS. This effect of FOS addition to soy protein-based powdered nutritional formulas is entirely unexpected.

Preferably, the inclusion of FOS in the powdered nutritional formulas of the present disclosure will improve the stability of lutein in the formulas over a shelf life of at least about 3 months, and more preferably for at least about 6 months. In one embodiment, at least about 85%, and more preferably, at least about 90% of the lutein present in the formula upon formulation will remain in the formula after a shelf life of about 3 months. In another embodiment, at least about 85%, and more preferably, at least about 90% of the lutein present in the formula upon formulation will remain in the formula after a shelf-life of about 6 months.

It has furthermore been discovered that when administered to an infant, the soy protein-based powdered nutritional formula of the present disclosure provides an infant stool pattern, frequency, and color more closely resembling that of breastfed infants, than conventional soy protein-based infant formulas that do not comprise FOS. Specifically, it has been discovered that when infants are administered a soy protein-based infant formula comprising FOS, their stool turns more yellowish in color and more closely resembles the color of the stool of breastfed infants, as compared to infants administered a soy protein-based infant formula that does not comprise FOS. In addition, it was discovered that the frequency of stools (i.e., average number of stools per day) trended higher in infants fed the soy protein-based formula containing FOS compared to the conventional soy protein-based formula without FOS; consequently, more closely resembling the higher stool frequency known with breastfed infants.

Fructooligosaccharides are saccharides comprising β-linked fructose units, which are preferably linked by β(2,1) and/or β(2,6) glycosidic linkages. Examples of suitable fructooligosaccharides include inulin, levan, and graminan. In general, inulin, levan, and graminan differ in the amount of branching that is present in their fructose chains and in the types of bonds connecting the individual fructose units. For example, levans generally consist of chains of fructose units that are typically connected by a β(2-6) bond. Although levans may occur as linear chain carbohydrates, they are more typically composed of branched fructose chains. In contrast, inulins generally consist of linear chains of fructose units that are typically connected by β(2-1) linkages. Graminans, or mixed type fructans, may comprise both β(2-1) and β(2-6) linkage bonds between fructose units. The fructooligosaccharide of the present disclosure preferably contains mostly β(2,1) glycosidic linked glucose at the reducing end.

Fructooligosaccharides may be found widely distributed in nature. For example, inulin may be found as a plant storage carbohydrate, and is common to plants of the Composite family. Inulin may be derived from a variety of plants, such as Jerusalem artichoke and Dahlia tuber, and is a major constituent of some herbs, such as burdock root, dandelion root, elecampane root, chicory root, and codonopsis, among others. Fructooligosaccharides are also commercially available as, for example, Raftilose®, Orafti® Synergy 1, Orafti® ST-Gel, Orafti® GR, Orafti® HP, Orafti® HPX, Orafti® LGI, Orafti® HSI, Orafti® L60, Orafti® L85, Orafti® L95, and Orafti® P95, all available from Beneo Orafti, Tienen, Belgium; NutraFlora® short chain FOS (available from GTC Nutrition, Golden, Colo.); Frutafit® inulin or Frutalose® oligofructose (available from Sensus, Roosendaal, Netherlands), and Actilight (available from Beghin-Meiji). Other commercially available FOS is available from Meiji Seika Kaisha, Tokyo, Japan, among others.

The fructooligosaccharide of the present disclosure will typically have a degree of polymerization of from 2 to about 20. Preferably the fructooligosaccharide has a degree of polymerization of from 2 to about 10. It should be understood that not all fructooligosaccharides present in a powdered nutritional formula of the present disclosure need to have the same degree of polymerization. For instance, the term “fructooligosaccharide” or “FOS” may also refer to a mixture of fructooligosaccharides having varying chain lengths; that is, long chain lengths and/or short chain lengths.

The powdered nutritional formulas of the present disclosure thus comprise fructooligosaccharides (FOS). The powdered nutritional formulas of the present disclosure will typically comprise, per 100 g of powdered formula, from about 0.5 g to about 7.0 g of FOS, including from about 1.1 g to about 3.0 g of FOS, from about 1.3 g to about 2.2 g of FOS, and from about 1.5 g to about 1.9 g of FOS.

### Nutrients

The powdered nutritional formulas of the present disclosure may comprise sufficient types and amounts of nutrients to meet the targeted dietary needs of the intended user. These powdered nutritional formulas may therefore comprise protein, carbohydrate, and a lipid component (all either organic or non-organic) in addition to the soy protein, carotenoids, and FOS discussed above. The powdered nutritional formulas may also include vitamins, minerals, or other ingredients suitable for use in nutritional powders.

For example, when the powdered nutritional formula is an adult formula, the protein component may comprise from about 10% to about 80% of the total caloric content of said nutritional formula; the carbohydrate component may comprise from about 10% to about 70% of the caloric content of said nutritional formula; and the lipid component may comprise from about 5% to about 50% of the total caloric content of said nutritional formula. These ranges are provided as examples only, and are not intended to be limiting.

When the powdered nutritional formula is a non-adult formula, such as an infant or toddler formula, the non-adult formula includes those embodiments in which the protein component may comprise from about 8% to about 80% of the caloric content of the nutritional formula; the carbohydrate component may comprise from about 10% to about 70% of the total caloric content of the nutritional formula; and the lipid component may comprise from about 10% to about 65% of the total caloric content of the nutritional formula. These ranges are provided as examples only, and are not intended to be limiting.

Table 1 provides additional ranges of various components for inclusion in the powdered nutritional formulas of the present disclosure.

TABLE 1

| Nutrient* | 1^{st} Embodiment | 2^{nd} Embodiment | 3^{rd} Embodiment |
|---|---|---|---|
| Carbohydrates: % | 20-85 | 30-60 | 35-55 |
| total calories | | | |
| Lipid: % total | 5-70 | 20-60 | 25-50 |
| calories | | | |
| Protein: % total | 2-75 | 5-50 | 7-40 |
| calories | | | |

*all numerical values preceded by the term “about”

Many different sources and types of carbohydrates, lipids, proteins, minerals and vitamins are known and can be used in the powdered nutritional formulas of the present disclosure, provided that such nutrients are compatible with the added ingredients in the selected formula, are safe for their intended use, and do not otherwise unduly impair product performance.

Carbohydrates suitable for use in the powdered nutritional formulas of the present disclosure can be simple, complex, or variations or combinations thereof. Non-limiting examples of suitable carbohydrates include hydrolyzed, intact, naturally and/or chemically modified cornstarch, maltodextrin, glucose polymers, sucrose, corn syrup, corn syrup solids, rice or potato derived carbohydrate, glucose, fructose, lactose, high fructose corn syrup and indigestible oligosaccharides such as fructooligosaccharides (FOS), and combinations thereof. In one particular embodiment, the powdered nutritional formulas of the present disclosure comprise sucrose, for example, from about 8 g to about 18 g of sucrose per 100 g of powdered formula. In other embodiments, the powdered nutritional formula of the present disclosure is substantially free of sucrose. Sucrose is a component of the dual carbohydrate blend in Isomil®, which provides the unique benefits of helping to maximize absorption and minimize malabsorption risks. The sucrose-free Isomil® provides options for the rare infants who may have sensitivity to sucrose.

Non-limiting examples of proteins suitable for use in the nutritional powders include extensively hydrolyzed, partially hydrolyzed or non-hydrolyzed proteins or protein sources, and can be derived from any known or otherwise suitable source such as milk (e.g., casein, whey), animal (e.g., meat, fish), cereal (e.g., rice, corn), vegetable (e.g., soy), or combinations thereof. The proteins for use herein can also include, or be entirely or partially replaced by, free amino acids known for use in nutritional formulas, non-limiting examples of which include tryptophan, glutamine, tyrosine, methionine, cysteine, arginine, and combinations thereof. Other (non-protein) amino acids typically added to nutritional formulas include carnitine and taurine. In some cases, the D-forms of the amino acids are considered as nutritionally equivalent to the L-forms, and isomer mixtures are used to lower cost (for example, D,L-methionine). As noted above, typically, at least about 15% of the total protein in the powdered nutritional formulas of the present disclosure is soy protein, more typically, at least about 50% of the total protein in the powdered nutritional formula is soy protein, and still more typically, at least about 75% of the total protein in the powdered nutritional formula is soy protein. In one embodiment, 100% of the total protein in the powdered nutritional formula is soy protein.

Non-limiting examples of lipids suitable for use in the powdered nutritional formulas include coconut oil, soy oil, corn oil, olive oil, safflower oil, high oleic safflower oil, MCT oil (medium chain triglycerides), sunflower oil, high oleic sunflower oil, palm and palm kernel oils, palm olein, canola oil, marine oils, cottonseed oils, long-chain polyunsaturated fatty acids such as arachidonic acid (ARA), docosahexaenoic acid (DHA), and eicosapentaenoic acid (EPA), and combinations thereof.

In addition to these food grade oils, structured lipids may be incorporated into the powdered nutritional formulas if desired. Structured lipids are known in the art, descriptions of which can be found in INFORM, Vol. 8, no. 10, page 1004, Structured lipids allow fat tailoring (October 1997). Structured lipids are predominantly triacylglycerols containing mixtures of medium and long chain fatty acids on the same glycerol nucleus. Structured lipids are also described in U.S. Pat. No. 6,160,007, which is also incorporated herein by reference.

The powdered nutritional formulas of the present disclosure may further comprise any of a variety of vitamins in addition to the components described above. Non-limiting examples of vitamins include vitamin A, vitamin D, vitamin E, vitamin K, thiamine, riboflavin, pyridoxine, vitamin B 12, niacin, folic acid, pantothenic acid, biotin, vitamin C, choline, chromium, carnitine, inositol, salts and derivatives thereof, and combinations thereof.

The powdered nutritional formulas may further comprise any of a variety of minerals, non-limiting examples of which include calcium, phosphorus, magnesium, iron, zinc, manganese, copper, iodine, sodium, potassium, chloride, and combinations thereof.

The infant formula embodiments of the present disclosure preferably comprise nutrients in accordance with the relevant infant formula guidelines for the targeted consumer or user population, as example of which would be the Infant Formula Act, 21 U.S.C. Section 350(a).

The powdered nutritional formulas of the present disclosure include those embodiments containing the carbohydrate, lipid, and protein concentrations described in Table 2 (Nutritional Formula Macronutrients).

TABLE 2*

| | | | g/100 g total | g/L |
|---|---|---|---|---|
| Nutrient | Embodiment | g/100 kcal | solids | (as fed) |
| Carbohydrate | 1^{st} Embodiment | 8-16 | 30-83 | 54-108 |
| | 2^{nd} Embodiment | 9-13 | 45-60 | 57-79 |
| | 3^{rd} Embodiment | 15-19 | 63-81 | 157-203 |
| Lipid | 1^{st} Embodiment | 3-8 | 15-42 | 20-54 |
| | 2^{nd} Embodiment | 4-6.6 | 20-30 | 27-45 |
| | 3^{rd} Embodiment | 2-5 | 8-21 | 20-53 |
| Protein | 1^{st} Embodiment | 1-3.9 | 5-20.5 | 7-24 |
| | 2^{nd} Embodiment | 1.5-3.4 | 10-17 | 10-23 |
| | 3^{rd} Embodiment | 3.5-6.0 | 14.8-25.3 | 37-63 |

*all numerical values preceded by the term “about”

The powdered nutritional formulas of the present disclosure include those embodiments that comprise per 100 kcal of reconstituted formula one or more of the following: vitamin A (from about 250 to about 1250 IU), vitamin D (from about 40 to about 150 IU), vitamin K (greater than about 4 mcg), vitamin E (at least about 0.3 IU), vitamin C (at least about 8 mg), thiamine (at least about 8 mcg), vitamin B12 (at least about 0.15 mcg), niacin (at least about 250 mcg), folic acid (at least about 4 mcg), pantothenic acid (at least about 300 mcg), biotin (at least about 1.5 mcg), choline (at least about 7 mg), and inositol (at least about 4 mg).

The powdered nutritional formulas of the present disclosure include those embodiments that comprise per 100 kcal of reconstituted formula one or more of the following: calcium (at least about 50 mg), phosphorus (at least about 25 mg), magnesium (at least about 6 mg), iron (at least about 0.15 mg), iodine (at least about 5 mcg), zinc (at least about 0.5 mg), copper (at least about 60 mcg), manganese (at least about 5 mcg), sodium (from about 20 to about 60 mg), potassium (from about 80 to about 200 mg), and chloride (from about 55 to about 150 mg).

### Optional Ingredients

The powdered nutritional formulas of the present disclosure may further comprise other optional components that may modify the physical, chemical, aesthetic or processing characteristics of the formulas or serve as pharmaceutical or additional nutritional components when used in the targeted population. Many such optional ingredients are known or other suitable for use in food and nutritional products, including infant formulas, and may also be used in the powdered nutritional formulas of the present disclosure, provided that such optional materials are compatible with the essential materials described herein, are safe for their intended use, and do not otherwise unduly impair product performance.

Non-limiting examples of such optional ingredients include preservatives, anti-oxidants, emulsifying agents, buffers, colorants, flavors, nucleotides, and nucleosides, additional probiotics, additional prebiotics, lactoferrin, and related derivatives, thickening agents and stabilizers, and so forth.

### Product Form

The powdered nutritional formulas of the present disclosure may have any caloric density suitable for the targeted or intended patient population, or provide such a density upon reconstitution of the nutritional powder. Most common caloric densities for the infant formula embodiments of the present disclosure are generally at least about 18 kcal/fl oz (609 kcal/liter), more typically from about 20 kcal/fl oz (676 kcal/liter) to about 25 kcal/fl oz (845 kcal/liter), even more typically from about 19 kcal/fl oz (642.5 kcal/liter) to about 24 kcal/fl oz (812 kcal/liter). Generally, the 22-24 kcal/fl oz formulas are more commonly used in pre-term or low birth weight infants, and the 19-21 kcal/fl oz (642.5 to 710 kcal/liter) formulas are more often used in term infants. Non-infant and adult powdered nutritional formulas may have any caloric density suitable for the targeted or intended population.

The powdered nutritional formulas of the present disclosure are typically in the form of flowable or substantially flowable particulate compositions, or at least particulate compositions that can be easily scooped and measured with a spoon or similar other device, wherein the compositions can easily be reconstituted by the intended user with a suitable aqueous fluid, typically water, to form a liquid nutritional formula for immediate oral or enteral use. In this context, “immediate” use generally means within about 48 hours, most typically within about 24 hours, preferably right after reconstitution. These powder embodiments include spray dried, agglomerated, dry mixed or other known or otherwise effective particulate form. The quantity of a powdered nutritional formula required to produce a volume suitable for one serving may vary.

The powdered nutritional formulas of the present disclosure may be packaged and sealed in single or multi-use containers, and then stored under ambient conditions for up to about 36 months or longer, more typically from about 12 to about 24 months. For multi-use containers, these packages can be opened and then covered for repeated use by the ultimate user, provided that the covered package is then stored under ambient conditions (e.g., avoid extreme temperatures) and the contents used within about one month or so.

### Methods of Use

The powdered nutritional formulas of the present disclosure may be used to improve the stool pattern of a formula fed infant. As discussed above, human milk is considered the “gold standard” nutritional source for infants by parents and professional care givers. Infants fed breast milk have stools that can be described as between watery and slightly above loose/mushy when using a five point scale to evaluate stool consistency (watery=1, loose/mushy=2, soft=3, formed=4 and hard=5). The breastfed infant typically has stools of a looser or watery consistency compared to formula-fed infants. Stools produced by breastfed infants are also predominantly yellowish, as compared to those typically produced by formula-fed infants. In contrast, the stool of soy formula-fed infants is typically green or brown. Additionally, the frequency of stools is higher in breastfed infants than in formula-fed infants.

It has now been discovered that inclusion of FOS in a soy protein-based infant formula results in an improved stool pattern in the formula-fed infant. In particular, it has been discovered that when infants are administered a soy protein-based infant formula comprising FOS, their stool turns more yellow in color and more closely resemble the color of the stool of breastfed infants, as compared to infants administered a soy protein-based infant formula that does not comprise FOS. Furthermore, it was discovered that the frequency of stools trended higher in infants fed the soy protein-based formula containing FOS compared to the conventional soy protein-based formula without FOS; consequently, more closely resembling the higher stool frequency known with breastfed infants.

Thus, in one aspect, the present disclosure is directed to a method for improving the stool pattern of a formula-fed infant. The method comprises reconstituting a powdered infant formula comprising, per 100 g of formula, from about 15 μg to about 300 μg of lutein; from about 0.5 g to about 7 g of a fructooligosaccharide; and soy protein; and administering the reconstituted infant formula to the infant. The reconstituted infant formulas of the present disclosure can be administered to the infant as a sole, primary, or supplemental nutrition source for any desired period of time.

### Methods of Manufacture

The powdered nutritional formulas of the present disclosure may be prepared by any known or otherwise effective technique suitable for making and formulating a nutritional powder or similar other formula, variations of which may depend upon variables such as the ingredient combination, packaging and container selection, and so forth, for the desired powdered nutritional formulas. Such techniques and variations for any given formula are easily determined and applied by one of ordinary skill in the nutritional powder or manufacturing arts.

The powdered nutritional formulas of the present disclosure, including the exemplified formulas described hereinafter, can therefore be prepared by any of a variety of known or otherwise effective formulation or manufacturing methods. These methods most typically involve the initial formation of an aqueous slurry containing carbohydrates, proteins, lipids, stabilizers or other formulation aids, vitamins, minerals, or combinations thereof. The slurry is emulsified, pasteurized, homogenized, and cooled. Various other solutions, mixtures, or other materials may be added to the resulting emulsion before, during, or after further processing. This emulsion can then be further diluted, heat-treated, and subsequently dried via spray-drying or the like to produce a powdered nutritional formula.

Other suitable methods for making powdered nutritional formulas are described, for example, in U.S. Pat. No. 6,365,218 (Borschel, et al.), U.S. Pat. No. 6,589,576 (Borschel, et al.), U.S. Pat. No. 6,306,908 (Carlson, et al.), U.S. Patent Application 20030118703 A1 (Nguyen, et al.), which descriptions are incorporated herein by reference.

### EXAMPLES

The following examples further describe and demonstrate specific embodiments within the scope of the present disclosure. The examples are given solely for the purpose of illustration and are not to be construed as limitations of the present disclosure, as many variations thereof are possible without departing from the spirit and scope of the disclosure. All exemplified amounts are weight percentages based upon the total weight of the composition, unless otherwise specified.

Each of the exemplified formulas is fed to humans to provide sole, primary, or supplemental nutrition. Each formula contains the combination of soy protein, lutein, and FOS, as described herein, wherein each formula exhibits greater stability of the lutein as compared to the same formula that does not comprise FOS.

### Examples 1-3

The following examples illustrate powdered soy protein based nutritional formulas of the present disclosure, including methods of making and using the nutritional formulas. Example 1 illustrates a powdered soy protein based nutritional formula comprising sucrose, while Example 2 illustrates a sucrose-free embodiment. Additionally, Examples 1 and 2 do not include lycopene. Example 3 is a powdered soy protein based nutritional formula that further comprises lycopene. Formula ingredients for each batch are listed in Tables 3 and 4.

TABLE 3
Powdered Soy Protein Based Nutritional Formulas Comprising
FOS and Lutein (Ingredients per 1000 Kg powdered formula)

| Ingredients | Example 1 | Example 2 |
|---|---|---|
| Corn Syrup Solids (kg) | 409.2 | 511.5 |
| Soy Protein Isolate partial hydrolysate (kg) | 145.5 | — |
| Soy Protein Isolate, identity preserved (kg) | — | 145.5 |
| High Oleic Sunflower Oil (kg) | 110.0 | 110.0 |
| Sucrose (kg) | 102.3 | — |
| Soy Oil (kg) | 73.1 | 73.1 |
| Coconut Oil (kg) | 76.3 | 76.3 |
| FOS (kg) | 17.5 | 20.5 |
| Tricalcium Phosphate (kg) | 15.6 | 15.6 |
| Potassium Citrate (kg) | 10.8 | 10.8 |
| 5% Potassium Hydroxide (kg) | 4.4 | 4.4 |
| Lecithin (kg) | 3.7 | 3.7 |
| Sodium Chloride (kg) | 3.2 | 3.2 |
| Arachidonic Acid Oil (ARA) (40%) (kg) | 2.5 | 2.5 |
| Potassium Chloride (kg) | 2.5 | 2.5 |
| Magnesium Chloride (kg) | 2.4 | 2.4 |
| L-Methionine (kg) | 1.6 | 1.6 |
| Docosahexaenoic Acid Oil (DHA) (40%) (kg) | 1.3 | 1.3 |
| Ascorbic Acid (kg) | 1.2 | 1.2 |
| m-Inositol (g) | 921.3 | 921.3 |
| Choline Chloride (g) | 550.0 | 550.0 |
| Taurine (g) | 410.7 | 410.7 |
| Ascorbyl Palmitate (g) | 346.2 | 346.2 |
| L-Tryptophan (g) | 260.3 | 260.3 |
| Mixed Tocopherols (g) | 107.8 | 107.8 |
| L-Carnitine (g) | 98.4 | 98.4 |
| Iron (from ferrous sulfate) (g) | 64.0 | 64.0 |
| Zinc (from zinc sulfate) (g) | 58.5 | 58.5 |
| Niacin (from niacinamide) (g) | 55.1 | 55.1 |
| Pantothenic Acid (g) | 48.5 | 48.5 |
| d-alpha Tocopheryl acetate (g) | 22.5 | 22.5 |
| Vitamin A Palmitate (g) | 14.0 | 14.0 |
| Lutein (20% free lutein) (g) | 7.0 | 9.0 |
| Riboflavin (g) | 6.4 | 6.4 |
| Thiamine (from thiamine chloride hydrochloride) | 6.2 | 6.2 |
| (g) | | |
| Vitamin B6 (g) | 3.6 | 3.6 |
| Copper (from cupric sulfate) (g) | 2.3 | 2.3 |
| Beta-carotene (30%) (g) | 1.9 | 1.9 |
| Iodine (mg) | 814.0 | 814.0 |
| Folic Acid (mg) | 778.9 | 778.9 |
| Phylloquinone (mg) | 397.7 | 397.7 |
| Biotin (mg) | 210.2 | 210.2 |
| Vitamin D3 (mg) | 101.5 | 101.5 |
| Selenium (mg) | 81.8 | 81.8 |
| Vitamin B12 (mg) | 18.4 | 18.4 |

TABLE 4
Powdered Soy Protein Based Nutritional Formula Comprising FOS,
Lutein, and Lycopene (Ingredients per 1000 Kg powdered formula)

| Ingredients | Example 3 |
|---|---|
| Corn Syrup Solids (kg) | 391.7 |
| Soy Protein Isolate (kg) | 146.7 |
| High Oleic Sunflower Oil (kg) | 114.7 |
| Sucrose (kg) | 97.9 |
| Soy Oil (kg) | 83.9 |
| Coconut Oil (kg) | 77.3 |
| FOS (kg) | 16.2 |
| Potassium Citrate (kg) | 15.3 |
| Tricalcium Phosphate (kg) | 11.7 |
| Calcium Phosphate Dibasic (kg) | 6.8 |
| Sodium Chloride (kg) | 3.4 |
| Arachidonic Acid Oil (ARA) (40%) (kg) | 2.9 |
| Magnesium Chloride (kg) | 2.6 |
| L-Methionine (kg) | 1.7 |
| Ascorbic Acid (kg) | 1.6 |
| Docosahexaenoic Acid Oil (DHA) (kg) | 1.1 |
| Choline Chloride (g) | 507.7 |
| Taurine (g) | 427.0 |
| Ascorbyl Palmitate (g) | 357.5 |
| Ferrous Sulfate (g) | 348.2 |
| m-Inositol (g) | 310.8 |
| Potassium Chloride (g) | 198.5 |
| Mixed Tocopherols (g) | 157.2 |
| Zinc Sulfate (g) | 129.0 |
| L-Carnitine (g) | 107.8 |
| Niacinamide (g) | 91.4 |
| d-alpha Tocopheryl acetate (g) | 75.3 |
| Calcium Pantothenate (g) | 54.8 |
| Cupric Sulfate (g) | 16.9 |
| Thiamine Chloride Hydrochloride (g) | 14.2 |
| Vitamin A Palmitate (g) | 14.1 |
| Riboflavin (g) | 6.3 |
| Pyridoxine Hydrochloride (g) | 5.7 |
| Folic Acid (g) | 1.9 |
| Potassium Iodide (g) | 1.0 |
| Lycpene (mg) | 937.0 |
| Phylloquinone (mg) | 819.7 |
| Biotin (mg) | 553.0 |
| Lutein (mg) | 393.5 |
| Sodium Selenate (mg) | 328.3 |
| Beta-carotene (mg) | 206.1 |
| Vitamin D3 (mg) | 99.2 |
| Cyancobalamin (mg) | 66.5 |

The exemplified formulas may be prepared as powdered nutritional formulas by making at least two separate slurries that are later blended together, heat treated, standardized, heat treated a second time, spray dried, agglomerated, dry blended, and packaged.

To begin manufacture of the exemplified powders, an oil blend is prepared. Soy oil, coconut oil, and high oleic sunflower (safflower oil) are combined in a suitable container or tank at 60-65° C. with agitation. Ascorbyl palmitate and mixed tocopherols are then added to the tank, followed by the oil soluble vitamins A, D, E, and K, and the carotenoids lutein, beta-carotene, and/or lycopene. Soy protein and L-methionine may be added at this point, or may be reserved until addition just prior to the heat treatment step. The mixture is agitated and held at 45° C.-65° C. until it is later blended with the other prepared slurries.

The carbohydrate-mineral slurry is then prepared. Potassium chloride, sodium chloride, magnesium chloride, and potassium iodide are added to heated water (60-72° C.), followed by the addition of di- and tri-calcium phosphates, all with agitation. Sucrose may then be added if a desired part of the formulation. The resulting slurry is held at 50-60° C. under agitation for at least 10 minutes.

The carbohydrate-mineral slurry, the oil blend, additional water as necessary, and the corn syrup are then added to a single tank. The ARA and DHA containing oils are added to this mixture. The pH of the mixture is adjusted to 6.6-7.0 using a potassium hydroxide solution. The adjusted mixture is then held at 50-60° C. under agitation for at least 10 minutes. Soy protein and L-methionine may also be added at this point, if not previously added to the oil blend.

The resulting mixture is then heated, for example, to 74-79° C., emulsified through a single stage homogenizer at 0-2.76 MPa, and passed through a two-stage homogenizer at 6.2-7.6 MPa and 2.1-3.4 MPa. The homogenized mixture is then held at a temperature of 73-79° C. for 16 seconds and then cooled to 1-7° C. The mixture is held under agitation.

A vitamin stock solution is prepared. Potassium citrate, ferrous sulfate, choline chloride, m-inositol, taurine, carnitine, iron, zinc, niacin, pantothenic acid, riboflavin, thiamine, vitamin B6, copper, iodine, folic acid, biotin, selenium, and vitamin B12 are added to water and agitated until well mixed. This vitamin mixture is added to the batch. Ascorbic acid is also added via a water solution to the batch.

The batch is then heated to 74-79° C. The batch is then held for 5 seconds at 107-111° C. using direct steam injection. The batch is then cooled to 71-82° C. before being pumped to a spray dryer and dried to a flowable powder. The powder is then packaged in suitable containers and sealed under a headspace of less than 3% oxygen.

The resulting formula is then used to provide a supplemental, primary, or sole source of nutrition to infants or other appropriate individuals.

Experiment 1

In this experiment, the stability of lutein in powdered nutritional formulas containing soy protein with or without added fructooligosaccharide (FOS) was evaluated.

To begin, three control formulas comprising lutein but no FOS and five test formulas comprising lutein plus about 1.7 g to 1.8 g FOS per 100 g of formula were prepared as described above for Examples 1-3. The control formulas were prepared using the ingredients set forth in Example 3, except with no FOS added, test formulas 1-4 were prepared using the ingredients set forth in Example 3 (including FOS), and test formula 5 was prepared using the ingredients set forth in Example 1 (including FOS).

The amount of lutein present in each formula was quantified within 2 weeks of manufacture (0 time), after 3 months of shelf life, and after 6 months of shelf life using a validated method for lutein quantification. Specifically, lutein was quantified by first reconstituting a sample of the experimental formula with water. The sample was then subjected to saponification and solvent extraction. Saponification was initiated with exposure of the sample to a metallic base, such as potassium hydroxide or sodium hydroxide in a solvent, such as methanol or ethanol. The sample was incubated with frequent vortexing, for example every 5 minutes for 1 hour. After saponification, the sample was extracted using hexane. Following saponification and solvent extraction, the lutein was separated from the remaining elements in the sample using reverse-phase HPLC, with a C30 column and gradient elution. The results are shown in Table 5. This method quantifies all the trans-, 13-cis, and 13′-cis lutein isomers.

TABLE 5
Use of FOS to Stabilize Lutein in Nutritional Formulas Comprising
Soy Protein

| | Control Formulas | | | Test Formulas (1.7-1.8 g FOS/100 g | | | | |
|---|---|---|---|---|---|---|---|---|
| | (no FOS added) | | | formula) | | | | |
| Lutein (mcg/kg) | 1 | 2 | 3 | 1 | 2 | 3 | 4 | 5 |
| 0 time | 648 | 1010 | 720 | 382 | 361 | 370 | 399 | 816 |
| 3 months | 495 | 825 | 571 | 304 | 273 | NT | NT | 825 |
| 6 months | 472 | 750 | 555 | 395 | 351 | 378 | 384 | 763 |
| % loss after 6 months | 27.2 | 25.7 | 22.9 | (+) 3.4 | 2.8 | (+) 2.2 | 3.8 | 6.5 |

NT = not tested.

Conclusion

As can be seen from Table 5, the average lutein loss over 6 months in the control formulas containing no FOS was 25.3%, whereas the average lutein loss over 6 months in the test formulas comprising FOS was only 4.4%. These results demonstrate that soy protein based nutritional formulas containing FOS are more resistant to lutein degradation over shelf lives of at least 6 months, than are soy protein based nutritional formulas that do not contain FOS.

Experiment 2

A study was conducted to evaluate the gastrointestinal (GI) tolerance of two different FOS-containing soy protein-based infant formulas and a commercially available soy protein-based infant formula (control) in normal term infants.

The study was a randomized, double blinded, multi-center, parallel, tolerance feeding study. One hundred and ninety-five (195) full term, healthy infants ranging in ages from 0 (enrolled on date of birth) to 8 days old with birth weight of ≦2490 g were enrolled. Subjects participated in the study from enrollment until 35 days of age.

Enrolled subjects were randomized to one of three study groups. Infants were administered the assigned study formula ad libitum as the sole source of nutrition from Study Visit 1 to Study Visit 3 (approximately 35 days of age). Specifically, the infants were administered either a control formula without FOS, or one of two test formulas. The control formula was Similac® Isomil® Advance® (Abbott Nutrition, Abbott Laboratories, Columbus, Ohio), which is a commercially available soy protein-based powdered infant formula containing 20% carbohydrate as sucrose. The two test formulas were 1) a soy-based, powdered infant formula with FOS, sucrose, lutein, and lycopene (i.e., the control formula supplemented with 2.5 g/L FOS (from GTC Nutrition) and lutein and lycopene) and 2) a soy-based, powdered sucrose-free infant formula with FOS, lutein, and lycopene (i.e., the control formula with 100% of the carbohydrate as corn syrup, and supplemented with 2.5 g/L of FOS and lutein and lycopene). The approximate composition of the control and test formulas per liter as fed is set forth in Table 6 below.

TABLE 6
Composition of Study Formulas (per liter as fed)

| | Control | Test | Test |
|---|---|---|---|
| Ingredients | Formula | Formula 1 | Formula 2 |
| Energy (kcal) | 676 | 676 | 676 |
| Protein (g) | 16.6 | 16.6 | 16.6 |
| Fat (g) | 36.9 | 36.9 | 36.9 |
| Carbohydrate (g)* | 69.7 | 68.45 | 68.45 |
| Short chain FOS (g) | 0 | 2.5 | 2.5 |
| Supplemented Carotenoids | | | |
| Beta-carotene (mcg) | 231 | 30 | 30 |
| Lutein (mcg) | 0^{†} | 53 | 53 |
| Lycopene (mcg) | 0^{†} | 81 | 81 |

*Total carbohydrate adjusted for the energy contributed by FOS (2.0 kcal/g)
^{†}Control formula may contain inherent trace levels of lutein and lycopene, but zero supplemental carotenoids.

Of the 195 enrolled subjects, seven did not receive any study product and two did not satisfy eligibility criteria and were excluded from further evaluation. Thus, there were 186 evaluable subjects at Study Visit 1. Of these subjects, 142 were evaluable at Study Visit 2, and 120 were evaluable at Study Visit 3. A subject was considered evaluable until one of the following exclusion events occurred: 1) subject entered into the study and did not satisfy eligibility criteria; 2) subject received wrong product, contrary to the randomization scheme; 3) subject was placed in an incorrect stratum; 4) dietary intake and/or stool records were not available for more than a total of 3 days between Study Visit and Study Visit 3, or 4) subject received an excluded concomitant treatment (e.g., consumption of human milk or formula other than the assigned study product, consumption of foods, juices, vitamin or mineral supplements or other sources of nutrition, consumption of rehydration and/or IV fluids, and/or use of medications or probiotics that may affect the assessment of the tolerance of the study product) for more than a total of 3 days between Study Visit 1 and Study Visit 3. Once a subject's data was classified as “non-evaluable,” all data collected after that visit was also excluded from the evaluable analyses. There were no statistically significant differences between the three study groups for subjects who were prematurely withdrawn from the study.

The study evaluated gastrointestinal tolerance of the study formulas using mean rank stool consistency (MRSC). The MRSC was calculated by assigning a score for stool consistency (I=watery, 2-loose/mushy, 3-soft, 4-formed, 5-hard), taking a daily mean, then computing the average of means over the period for each infant. Secondary variables, such as average number of stools per day and the percent of feedings with spit up/vomit associated with (within one hour) feeding from Study Visit 1 (0 to 8 days of age) to Study Visit 3 (35 days of age ±3 days) were also evaluated. Variables such as predominant stool consistency, color and odor, percentages of stool consistency and color, occurrence of fussiness, occurrence of gas, and average daily study product intake (average volume, average number of feedings) were determined from Study Visit 1 to Study Visit 3; weight, length, and head circumference were determined at Study Visits 1, 2 (14 days of age ±3 days), and 3; physical assessment including hydration status was determined at Study Visits 2 and 3; and urine specific gravity was determined at Study Visits 2 and 3. Parents were also asked to complete daily stool record forms from Study Day 1 (starting with the first study feeding) to Study Visit 3 (35 days of age ±3 days), containing descriptions of the various stool categories being evaluated.

Gastrointestinal Tolerance and Safety: The results indicated that MRSC was not significantly different (p>0.05) between the three study formulas from Study Visit 1 to Study Visit 3 (35 days of age) (see Table 7). The stool consistency ratings were between loose/mushy and soft. There were also no significant differences noted between the three study formulas in percent of feedings with spit up/vomit associated with (within one hour) feeding from Study Visit 1 to Study Visit 3 (data not shown). Growth measures (weight, length, and head circumference) were also evaluated during the study, and were not significantly different between the three study formulas (data not shown). Safety measures including significant adverse events, adverse events, and hydration status as denoted by urine specific gravity were not significantly different between the study formulas (data not shown).

TABLE 7
Mean Rank Stool Consistency (MRSC) in Evaluable Subjects

| Average MRSC | Control | Test Formula 1 | Test Formula 2 |
|---|---|---|---|
| Study Day 1-14 | | | |
| Mean ± SEM | 2.5 ± 0.1 | 2.6 ± 0.1 | 2.5 ± 0.1 |
| Median | 2.4 | 2.7 | 2.4 |
| SD | 0.7 | 0.8 | 0.6 |
| Minimum/Maximum | 1.3, 4.5 | 1.0, 5.0 | 1.0, 3.9 |
| N | 51 | 57 | 57 |
| Study Day 15-35 | | | |
| Mean ± SEM | 2.6 ± 0.1 | 2.7 ± 0.1 | 2.5 ± 0.1 |
| Median | 2.7 | 2.7 | 2.5 |
| SD | 0.7 | 0.6 | 0.7 |
| Minimum/Maximum | 1.8, 4.8 | 1.1, 3.6 | 1.1, 4.2 |
| N | 40 | 41 | 46 |
| Study Day 1-35 | | | |
| Mean ± SEM | 2.6 ± 0.1 | 2.7 ± 0.1 | 2.5 ± 0.1 |
| Median | 2.5 | 2.7 | 2.6 |
| SD | 0.6 | 0.7 | 0.6 |
| Minimum/Maximum | 1.7, 4.5 | 1.0, 5.0 | 1.0, 3.8 |
| N | 49 | 53 | 54 |

Stool Characteristics: There were no significant differences between the study groups in most of the stool characteristics evaluated, including predominant stool consistency, color, odor, and gassiness. The percentages of hard stools were significantly higher in infants administered test formula 1 as compared to test formula 2 at study days 1-14, but not at study days 15-35 (data not shown). While there were no significant differences observed between study groups in percentages of brown, green, or black stools (data not shown), the percentages of yellow stools were significantly higher in infants administered test formula 1 than in infants administered the control formula at study days 1-14. No statistically significant difference was observed between the infants administered test formula 1 and infants administered the control formula at study days 15-35, although the trend of higher percentages of yellow stools observed in infants administered test formula 1 was still apparent during study days 15-35. More yellowish stools as compared to infants administered the control formula were also observed throughout the study for infants administered test formula 2. These results are shown in Table 8.

TABLE 8
Percent of Yellow Stools in Evaluable Subjects

| % Yellow Stools | Control | Test Formula 1 | Test Formula 2 |
|---|---|---|---|
| Study Day 1-14 | | | |
| Mean ± SEM | 51.2 ± 5.1 | 65.3 ± 4.8 | 58.3 ± 4.7 |
| Median | 46.7 | 78.6 | 63.6 |
| SD | 36.7 | 36.5 | 35.4 |
| Minimum/Maximum | 0, 100 | 0, 100 | 0, 100 |
| N | 51 | 57 | 57 |
| Study Day 15-35 | | | |
| Mean ± SEM | 40.2 ± 6.5 | 50.9 ± 6.4 | 53.0 ± 6.1 |
| Median | 23.9 | 54.5 | 56.9 |
| SD | 41.3 | 41.1 | 41.5 |
| Minimum/Maximum | 0, 100 | 0, 100 | 0, 100 |
| N | 40 | 41 | 46 |
| Study Day 1-35 | | | |
| Mean ± SEM | 48.7 ± 5.4 | 60.2 ± 5.0 | 55.0 ± 5.0 |
| Median | 48.3 | 66.7 | 54.9 |
| SD | 37.5 | 36.3 | 36.5 |
| Minimum/Maximum | 0, 100 | 0, 100 | 0, 100 |
| N | 49 | 53 | 54 |

As can be seen from these results, infants administered the test formulas comprising added FOS had a higher percentage of yellow stool than infants administered the control formula containing no FOS. In contrast, the control formula containing no FOS consistently produced a more greenish stool color trend throughout the feeding study compared to the two FOS-containing formulas, despite a lack of statistically significant difference (Table 9). The production of yellowish stools in infants may be desirable, as stools produced by human milk fed infants are predominantly yellowish, as compared to those typically produced by formula-fed infants.

TABLE 9
Percent of Green Stools in the Evaluable Subjects

| % Green Stools | Control | Test Formula 1 | Test Formula 2 |
|---|---|---|---|
| Study Day 1-14 | | | |
| Mean ± SEM | 28.3 ± 4.2 | 18.7 ± 3.9 | 23.4 ± 4.4 |
| Median | 20.7 | 2.6 | 5.3 |
| SD | 30.2 | 29.8 | 32.9 |
| Minimum/Maximum | 0.0, 100.0 | 0.0, 100.0 | 0.0, 100.0 |
| N | 51 | 57 | 57 |
| Study Day 15-35 | | | |
| Mean ± SEM | 44.6 ± 6.2 | 33.7 ± 5.9 | 28.7 ± 5.5 |
| Median | 40.9 | 20.6 | 3.9 |
| SD | 39.1 | 37.6 | 37.5 |
| Minimum/Maximum | 0.0, 100.0 | 0.0, 100.0 | 0.0, 100.0 |
| N | 40 | 41 | 46 |
| Study Day 1-35 | | | |
| Mean ± SEM | 35.1 ± 4.6 | 25.4 ± 4.3 | 26.9 ± 4.6 |
| Median | 33.3 | 11.3 | 7.0 |
| SD | 32.4 | 31.4 | 34.0 |
| Minimum/Maximum | 0.0, 91.2 | 0.0, 100.0 | 0.0, 100.0 |
| N | 49 | 53 | 54 |

With respect to stool frequency, there was a noticeable and consistent trend of higher daily average numbers of stool throughout the study with the two FOS-containing formulas versus the control formula, which contains no FOS, notwithstanding the absence of statistically significant differences (Table 10). Increased stool frequency is desirable as breastfed infants notable for having more frequent stools and more stools that are soft or loose/mushy.

TABLE 10
Average Numbers of Stools per Day in Evaluable Subjects

| | Control | Test Formula 1 | Test Formula 2 |
|---|---|---|---|
| Study Day 1-14 | | | |
| Mean ± SEM | 2.9 ± 0.3 | 3.3 ± 0.3 | 3.1 ± 0.3 |
| Median | 2.7 | 2.8 | 2.4 |
| SD | 1.8 | 2.3 | 2.6 |
| Minimum/Maximum | 0.4, 10.0 | 0.5, 12.0 | 0.3, 13.2 |
| N | 48 | 55 | 56 |
| Study Day 15-35 | | | |
| Mean ± SEM | 2.1 ± 0.2 | 2.7 ± 0.3 | 2.7 ± 0.3 |
| Median | 1.9 | 2.2 | 2.0 |
| SD | 1.2 | 1.9 | 2.0 |
| Minimum/Maximum | 0.3, 6.1 | 0.6, 7.0 | 0.2, 8.6 |
| N | 40 | 41 | 46 |
| Study Day 1-35 | | | |
| Mean ± SEM | 2.4 ± 0.2 | 3.1 ± 0.3 | 2.8 ± 0.3 |
| Median | 2.0 | 2.6 | 2.1 |
| SD | 1.6 | 2.2 | 2.0 |
| Minimum/Maximum | 0.4, 10.0 | 0.5, 12.0 | 0.4, 9.0 |
| N | 46 | 51 | 53 |

### CONCLUSION

The results of the study indicate that the two test formulas containing FOS supported normal growth. They were generally well tolerated and were favorably comparable to the established control formula that had no added FOS.

Furthermore, the results of the study suggest that the addition of FOS to a soy protein-based infant formula results in a stool pattern, an in particular a stool color and stool frequency, that more closely resembles that produced by human milk fed infants.

What is claimed is:

1. A powdered nutritional formula comprising, per 100 g of formula:
from about 15 μg to about 175 μg of lutein;
from about 1.1 g to about 3 g of a fructooligosaccharide; and
soy protein.

2. The powdered nutritional formula of claim 1 wherein at least about 50% of the total protein in the formula is soy protein.

3. The powdered nutritional formula of claim 1 wherein 100% of the total protein in the formula is soy protein.

4. The powdered nutritional formula of claim 1 wherein the formula comprises, per 100 g of formula, from about 1.5 g to about 1.9 g of the fructooligosaccharide.

5. The powdered nutritional formula of claim 1 wherein the formula further comprises a carotenoid selected from the group consisting of beta-carotene, lycopene, and combinations thereof.

6. The powdered nutritional formula of claim 1 wherein the formula is substantially free of lycopene.

7. The powdered nutritional formula of claim 1 further comprising at least one of vitamins, minerals, carbohydrate, lipid, and protein.

8. The powdered nutritional formula of claim 7 comprising, as a percentage of total calories, about 10% to about 70% carbohydrate, about 10% to about 65% lipid component, and about 8% to about 80% protein.

9. The powdered nutritional formula of claim 1, wherein the formula further comprises sucrose.

10. The powdered nutritional formula of claim 9, wherein the formula comprises, per 100 g of formula, from about 8 g to about 18 g of sucrose.

11. The powdered nutritional formula of claim 1, wherein the formula is substantially free of sucrose.

12. The powdered nutritional formula of claim 1, wherein the formula is selected from the group consisting of an infant formula and a toddler formula.

13. The powdered nutritional formula of claim 1, wherein at least about 90% of the lutein in the formula upon formulation remains in the formula after a shelf life of about 3 months.

14. The powdered nutritional formula of claim 1, wherein at least about 85% of the lutein in the formula upon formulation remains in the formula after a shelf life of about 6 months.

15. A method for improving the stool pattern of a formula-fed infant, the method comprising:
reconstituting a powdered infant formula comprising, per 100 g of formula, from about 15 μg to about 175 μg of lutein; from about 1.1 g to about 3 g of a fructooligosaccharide; and soy protein; and
administering the reconstituted infant formula to the infant.

16. The method of claim 15 wherein after administering the reconstituted infant formula to the infant, the stool pattern of the infant more closely resembles that of a breastfed infant.

17. The method of claim 16 wherein after administering the reconstituted infant formula to the infant, the stool of the infant turns yellow.

18. The method of claim 15, wherein the powdered infant formula is substantially free of sucrose.

19. A powdered nutritional formula comprising, per 100 g of formula:
from about 15 μg to about 300 μg of lutein;
from about 0.5 g to about 7 g of a fructooligosaccharide; and
soy protein.

20. The powdered nutritional formula of claim 19 wherein 100% of the total protein in the formula is soy protein.

21. The powdered nutritional formula of claim 19, wherein the formula is selected from the group consisting of an infant formula and a toddler formula.

22. A method for improving the stool pattern of a formula-fed infant, the method comprising:
reconstituting a powdered infant formula comprising, per 100 g of formula, from about 15 μg to about 300 μg of lutein; from about 0.5 g to about 7 g of a fructooligosaccharide; and soy protein; and
administering the reconstituted infant formula to the infant.

23. The method of claim 22 wherein after administering the reconstituted infant formula to the infant, the stool pattern of the infant more closely resembles that of a breastfed infant.

24. A powdered infant formula comprising, per 100 g of formula:
lutein;
a fructooligosaccharide; and
soy protein.
